(19) United States
(12) Patent Application Publication
(10) Pub. No.: US 2024/0284493 A1
(43) Pub. Date: Aug. 22, 2024

(54) SYSTEMS AND METHODS FOR FACILITATING DELAY AWARE SCHEDULING OF NETWORK DATA COMMUNICATIONS

(71) Applicant: Meta Platforms Technologies, LLC, Menlo Park, CA (US)

(72) Inventors: Zhu Ji, Cupertino, CA (US); Yee Sin Chan, San Francisco, CA (US); Jimin Liu, Bellevue, WA (US); Xiaodi Zhang, San Ramon, CA (US)

(73) Assignee: Meta Platforms Technologies, LLC, Menlo Park, CA (US)

(21) Appl. No.: 18/397,521

(22) Filed: Dec. 27, 2023

Related U.S. Application Data
(60) Provisional application No. 63/446,203, filed on Feb. 16, 2023.

(51) Int. Cl. H04W 72/51; H04W 28/14

(52) U.S. Cl. CPC H04W 72/51; H04W 28/14

(57) ABSTRACT

Disclosed herein are aspects related to a device that can include a wireless communication interface and one or more processors. The one or more processors can allocate at least a first data burst and a second data burst to a data buffer. The one or more processors can assign a timer corresponding to an amount of time for output of the first data burst until one or more timing criteria expire. The one or more processors can assign, responsive to the first data burst and the second data burst each representing periodic network traffic, an index indicative of the position of the second data burst in the data buffer relative to the first data burst. The wireless communications interface can transmit the first data burst, the timer for the first data burst, the second data burst, and the index for the second data burst.

### CROSS-REFERENCE TO RELATED APPLICATIONS

The present application claims the benefit of and priority to U.S. Provisional Application No. 63/446,203, filed Feb. 16, 2023, the disclosure of which is incorporated herein by reference in its entirety.

### FIELD OF DISCLOSURE

The present disclosure is generally related to communication for rendering artificial, mixed, virtual, or extended reality, including but not limited to systems and methods for facilitating delay aware scheduling of network data communications, such as for remaining time communication.

### BACKGROUND

Artificial/extended reality (XR) such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space).

### SUMMARY

Systems that implement XR can transmit data to and receive data from remote devices, such as network base stations, as part of providing XR experiences. Due to various factors including size, weight, and power considerations, it can be useful for such systems, such as portable user equipment (UE) devices, to communicate information relating to delays or expected delays for communication of data packets (e.g., of protocol data units (PDUs)). However, such control can affect quality of service (QOS) of the XR experience, such as by affecting latency; similarly, XR data, such as video frames to be presented in an order, may be expected to be delivered according to a periodic schedule (e.g., frame rate), and thus such systems can cause data to be discarded rather than transmitted/received after the data would be useful (e.g. after the data becomes stale), which can affect (e.g., reduce) QoS.

Systems and methods in accordance with the present disclosure can enable more effective delay-aware scheduling of network communications by controlling how remaining time information for data bursts is communicated. For example, responsive to detecting that a data burst represents periodic data, the system can use an index of the data burst, together with remaining time information of another data burst representing periodic data, to indicate the remaining time information for the data burst. This can reduce overhead by reducing a number of instances in which the remaining time information is to be generated and/or assigned to a network data element (e.g., header) for the data bursts.

Various implementations disclosed herein are related to a device that can include a wireless communications interface and one or more processors. The one or more processors can allocate at least a first data burst and a second data burst to a data buffer. The one or more processors can assign, to the first data burst, a timer corresponding to an amount of time for output of the first data burst until one or more timing criteria expire. The one or more processors can assign, to the second data burst, responsive to the first data burst and the second data burst each representing periodic network traffic, an index indicative of the position of the second data burst in the data buffer relative to the first data burst. The one or more processors can cause the wireless communications interface to transmit the first data burst and the timer for the first data burst, and to transmit the second data burst and the index for the second data burst.

In some implementations, the one or more processors can assign the timer in a header associated with the first data burst. In some implementations, the one or more processors can be configured to not assign the timer to the second data burst responsive to the first data burst and the second data burst each representing periodic network traffic. In some implementations, the one or more timing criteria comprise at least one of a PDU set delay budget (PSDB) or a PDU set discard time (PSDT).

In some implementations, the first data burst and the second data burst each include one or more of protocol data unit (PDU) sets. In some implementations, the one or more processors can generate the one or more PDU sets of the first data burst and the second data burst using a same application. The one or more processors can assign, to the one or more PDU sets of the first data burst and the second data burst, a same value of a PDU set importance score.

In some implementations, the first data burst and the second data burst are each representative of at least one of image data, audio data, or video data. In some implementations, the one or more processors can monitor a difference of timing of output of the second data burst relative to an expected timing corresponding to the timer, and can transmit, using the wireless communications interface, responsive to the difference meeting a correction condition, an indication of the difference.

Various implementations disclosed herein relate to a system that can include one or more processors. The one or more processors can allocate at least a first data burst and a second data burst to a data buffer. The one or more processors can assign, to the first data burst, a timer corresponding to an amount of time for output of the first data burst until one or more timing criteria expire. The one or more processors can assign, to the second data burst, responsive to the first data burst and the second data burst each representing periodic network traffic, an index indicative of the position of the second data burst in the data buffer relative to the first data burst. The one or more processors can cause a wireless communications interface to transmit the first data burst and the timer for the first data burst, and to transmit the second data burst and the index for the second data burst.

In some implementations, the one or more processors can assign the timer in a header associated with the first data burst. In some implementations, the one or more processors can be to not assign the timer to the second data burst responsive to the first data burst and the second data burst each representing periodic network traffic. In some implementations, the one or more timing criteria comprise at least one of a PDU set delay budget (PSDB) or a PDU set discard time (PSDT).

In some implementations, the first data burst and the second data burst each include one or more of protocol data unit (PDU) sets. In some implementations, the one or more processors can generate the one or more PDU sets of the first data burst and the second data burst using a same application. The one or more processors can assign, to the one or more PDU sets of the first data burst and the second data burst, a same value of a PDU set importance score.

In some implementations, the first data burst and the second data burst are each representative of at least one of image data, audio data, or video data. In some implementations, the one or more processors can monitor a difference of timing of output of the second data burst relative to an expected timing corresponding to the timer, and can transmit, using the wireless communications interface, responsive to the difference meeting a correction condition, an indication of the difference.

Various implementations disclosed herein relate to a method. The method can include allocating, by one or more processors, a first data burst and a second data burst to a data buffer. The method can include assigning, by the one or more processors, to the first data burst, a timer corresponding to an amount of time for output of the first data burst until one or more timing criteria expire. The method can include selecting, by the one or more processors, according to a timing characteristic of the first data burst and the second data burst, one of a timer-based communication mode for communicating remaining time information for the second data burst or an index-based communication mode for communicating the remaining time information for the second data burst. The method can include transmitting, by the one or more processors using a wireless communications interface, the first data burst and the timer. The method can include transmitting, by the one or more processors using the wireless communications interface, the second data burst according to the selected one of the timer-based communication mode or the index-based communication mode.

In some implementations, the method includes generating, by the one or more processors, the one or more PDU sets of the first data burst and the second data burst using a same application. The method can include assigning, to the one or more PDU sets of the first data burst and the second data burst, a same value of a PDU set importance score.

In some implementations, the first data burst and the second data burst are each representative of at least one of image data, audio data, or video data. The method can include monitoring, by the one or more processors, a difference of timing of output of the second data burst relative to an expected timing corresponding to the timer. The method can include transmitting, using the wireless communications interface, responsive to the difference meeting a correction condition, an indication of the difference.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a diagram of an example wireless communication system, according to an example implementation of the present disclosure.

FIG. 5 is a block diagram of a system for network communications, according to an example implementation of the present disclosure.

FIG. 6 is a schematic diagram of protocol data unit (PDU) set communication as data bursts with remaining time information, according to an example implementation of the present disclosure.

FIG. 7 is a flow chart of a method of facilitating communication of remaining time information for delay aware scheduling, according to an example implementation of the present disclosure.

### DETAILED DESCRIPTION

Before turning to the figures, which illustrate certain implementations in detail, it should be understood that the present disclosure is not limited to the details or methodology set forth in the description or illustrated in the figures. It should also be understood that the terminology used herein is for the purpose of description only and should not be regarded as limiting.

Systems and methods in accordance with the present disclosure can use delay information relating to data to be communicated, such as data packets and/or data bursts in a buffer, to facilitate routing, scheduling, and other operations to facilitate timely transmission of data. Various types of data to be communicated (e.g., over one or more wireless communication links), may have criteria for timing of the communication of the data, such as latency/jitter criteria. For example, XR data, such as video frames and/or audio data, can have latency criteria. The data can be represented as data bursts (e.g., data produced by an application in a relatively short period of time), which can be assigned to one or more protocol data units (PDUs) of one or more PDU sets. For example, data corresponding to a slice or frame of a video may form a data burst that can be assigned or allocated across multiple PDU sets. Data packets and/or PDU sets can be placed in a buffer prior to transmission; various such data packets and/or PDU sets may have varying timing criteria, such as quality of service (QOS), latency, and/or jitter criteria, which can make it difficult to effectively transmit buffered data while satisfying appropriate criteria.

Systems and methods in accordance with the present disclosure can use delay information relating to data, such as relating to data bursts (e.g., across multiple PDU sets), to enable devices such as user equipment (e.g., UEs) and/or base stations (e.g., gNBs) to more effectively process and transmit buffered data. For example, various elements of a data structure (e.g., data packet, data burst, and/or PDU set), such as header information, buffer information, start frames, end frames, or various combinations thereof, can be assigned an indication of delay information. The delay information can indicate an amount of timing available (e.g., remaining) until a timing criteria, such as latency requirement, for the data structure to expire. Various devices (e.g., resource provisioning engine of UE) can evaluate the delay information to control communication of the data structure; the delay information can be updated by being reduced in value over time to facilitate tracking how much time may be remaining until the timing criteria expires.

A PDU set can include one or more PDU(s) that includes a payload of a unit of information generated at an application level, such as a frame or video slice for XR or extended reality management (XRM) services. In some implementations, each PDU in a PDU and/or each PDU set in a data burst have a same PDU set importance score. In some implementations, all PDUs in a PDU set may be needed by the application layer to use the corresponding unit of information, or the application layer may be capable of recovering parts of or all of the information unit even if some PDUs are missing. Applications can output multiple PDUs as a data burst (e.g., one or more PDU sets). For example, a transmitter may send PDUs as a data burst, where a set of multiple PDUs are generated and sent by an application in a short period of time (or burst). Each data burst can be composed of multiple PDU sets. As an example, a first PDU set may represent an I frame of video data, while a second PDU set may represent a P frame of the video data.

Various quality of services (QOS) rules and/or classifications may be applied to network data traffic (e.g., an IP flow), including PDUs and data bursts. For example, UL/DL traffic classification can be based on packet detection rules for DL and/or a UL traffic filter for UL; various tuples (e.g., source IP, destination IP, source port, destination port, protocol ID) can be used to perform the classification.

With respect to PDUs, a PDU set delay budget (PSDB) can define an upper bound for an amount of time that a PDU set may be delayed between particular points in a network pathway, such as between a device (e.g., user equipment (UE), such as various devices described herein) and an N6 point at a user plane function (UPF). For example, the PSDB can be applied to a DL PDU set received by the UPF over the N6 interface, and to the UL PDU sent by the UE. In the case of network access, the PSDB can support the configuration of scheduling and link layer functions (e.g., the setting of scheduling priority weights and hybrid automatic repeat request (HARQ) target operating points). For a given 5G QoS identifier (5QI), which can indicate one or more QoS parameters or characteristics, the value of the PSDB can be the same for UL and DL. For some classifications of data (e.g., based on particular QoS rules to be applied to the data), a PDU set may be counted as lost if delayed more than the PSDB.

A PDU set discard time (PSDT) can define an upper bound for an amount of time that a PDU set has been waiting for transmission at the sender of a link layer protocol (e.g., RLC in RAN) before being discarded. The PSDT can apply to the DL PDU set received by the UPF over the N6 interface, and to the UL PDU set sent by the UE.

The delay information (e.g., delay timer) can be assigned to the data structure in various manners. For example, a timer can be assigned to each data burst in an uplink data buffer (e.g., for each PDU set corresponding to the data burst, such that each PDU set has the same remaining time). This can be useful, for example, in situations where uplink jitter may not be present, such as where a codec is based on a hardware implementation. For periodic traffic, the system can index the timing information for each data burst in the buffer, which can reduce overhead (e.g., given a predetermined timing criteria that may correspond to each data burst according to a type of data of the data burst, such as where multiple data bursts can be assigned sequential indices while all having an analogous timing criteria (e.g., 30 ms latency criteria=30 ms delay timer for first data burst, 60 ms delay timer for second data burst, 90 ms delay timer for third data burst). Out of sync timing information can be corrected using a MAC control element (e.g., where buffer data overflow occurs) or UAI/UCI signaling. In some implementations, the delay timer information includes an indication of a start frame and an end frame of the data burst, to facilitate using the same delay timer across the data burst. For non-periodic traffic, each data burst can have a respective (e.g., individually determined) delay time. Various delay timers can be communicated using, for example, using uplink assistance information (UAI) or uplink control information (UCI). Delay timers can be indicated on a logical channel (LCH) basis.

In one approach, a device includes a wireless communications interface and one or more processors. The one or more processors can assign a delay timer to a data packet for communication by the wireless communications interface, the delay timer indicative of an amount of time available for transmission of the data packet until one or more timing criteria expire. The one or more processors can assign the data packet, having the delay timer assigned to the data packet, to a buffer. In some implementations, the delay timer is provided as an explicit timer value for the data packet (e.g., data burst), such as where the data burst is a first burst of periodic traffic after another data burst of non-periodic (or different periodicity) traffic. In some implementations, the delay timer is not explicitly provided where the data burst is for periodic traffic following a previous data burst of periodic traffic (e.g., of the same periodicity), which can allow overhead information to be reduced as the index for the data burst can be indicated (e.g., implicitly implied) without having to attach the timing information to the data burst.

Although various implementations disclosed herein are provided with respect to wearable devices, principles disclosed herein can be applied to any other type of devices such as handheld, mobile or small form factor devices (e.g., smart phones, tablet computers, laptops, etc.).

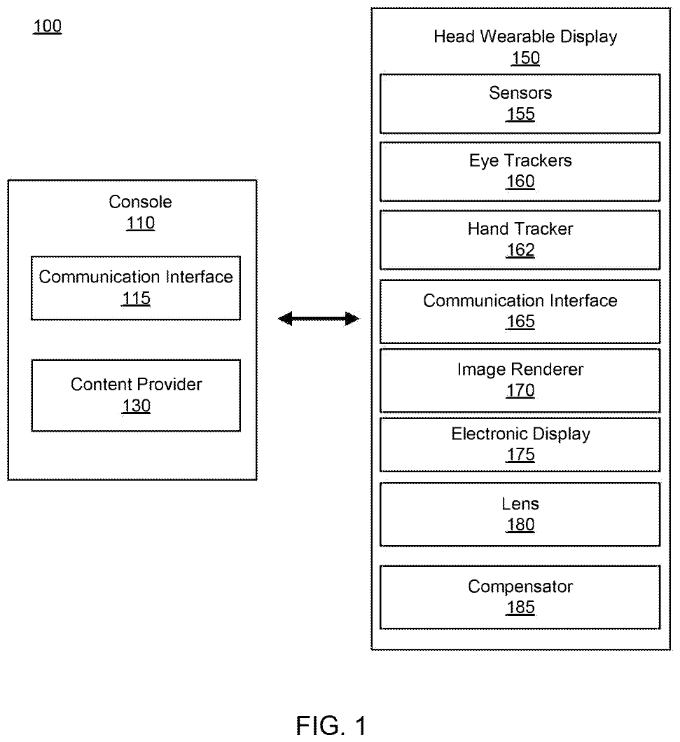

FIG. 1 is a block diagram of an example artificial reality system environment 100. In some implementations, the artificial reality system environment 100 includes a HWD 150 worn by a user, and a console 110 providing content of artificial reality to the HWD 150. The HWD 150 may be referred to as, include, or be part of a head mounted display (HMD), head mounted device (HMD), head wearable device (HWD), head worn display (HWD) or head worn device (HWD). The HWD 150 may detect its location and/or orientation of the HWD 150 as well as a shape, location, and/or an orientation of the body/hand/face of the user, and provide the detected location/or orientation of the HWD 150 and/or tracking information indicating the shape, location, and/or orientation of the body/hand/face to the console 110. The console 110 may generate image data indicating an image of the artificial reality according to the detected location and/or orientation of the HDM 150, the detected shape, location and/or orientation of the body/hand/face of the user, and/or a user input for the artificial reality, and transmit the image data to the HWD 150 for presentation. In some implementations, the artificial reality system environment 100 includes more, fewer, or different components than shown in FIG. 1. In some implementations, functionality of one or more components of the artificial reality system environment 100 can be distributed among the components in a different manner than is described here. For example, some of the functionality of the console 110 may be performed by the HWD 150. For example, some of the functionality of the HWD 150 may be performed by the console 110. In some implementations, the console 110 is integrated as part of the HWD 150.

In some implementations, the HWD 150 is an electronic component that can be worn by a user and can present or provide an artificial reality experience to the user. The HWD 150 may render one or more images, video, audio, or some combination thereof to provide the artificial reality experience to the user. In some implementations, audio is presented via an external device (e.g., speakers and/or headphones) that receives audio information from the HWD 150, the console 110, or both, and presents audio based on the audio information. In some implementations, the HWD 150 includes sensors 155, eye trackers 160, a hand tracker 162, a communication interface 165, an image renderer 170, an electronic display 175, a lens 180, and a compensator 185. These components may operate together to detect a location of the HWD 150 and a gaze direction of the user wearing the HWD 150, and render an image of a view within the artificial reality corresponding to the detected location and/or orientation of the HWD 150. In other implementations, the HWD 150 includes more, fewer, or different components than shown in FIG. 1.

In some implementations, the sensors 155 include electronic components or a combination of electronic components and software components that detect a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some implementations, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some implementations, the eye trackers 160 include electronic components or a combination of electronic components and software components that determine a gaze direction of the user of the HWD 150. In some implementations, the HWD 150, the console 110 or a combination of them may incorporate the gaze direction of the user of the HWD 150 to generate image data for artificial reality. In some implementations, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some implementations, the eye trackers 160 incorporate the orientation of the HWD 150 and the relative gaze direction with respect to the HWD 150 to determine a gate direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers 160 may determine that the gaze direction of the user is 20 degrees from the reference direction. In some implementations, a user of the HWD 150 can configure the HWD 150 (e.g., via user settings) to enable or disable the eye trackers 160. In some implementations, a user of the HWD 150 is prompted to enable or disable the eye trackers 160.

In some implementations, the hand tracker 162 includes an electronic component or a combination of an electronic component and a software component that tracks a hand of the user. In some implementations, the hand tracker 162 includes or is coupled to an imaging sensor (e.g., camera) and an image processor that can detect a shape, a location and an orientation of the hand. The hand tracker 162 may generate hand tracking measurements indicating the detected shape, location and orientation of the hand.

In some implementations, the communication interface 165 includes an electronic component or a combination of an electronic component and a software component that communicates with the console 110. The communication interface 165 may communicate with a communication interface 115 of the console 110 through a communication link. The communication link may be a wireless link. Examples of the wireless link can include a cellular communication link, a near field communication link, Wi-Fi, Bluetooth, 60 GHz wireless link, or any communication wireless communication link. Through the communication link, the communication interface 165 may transmit to the console 110 data indicating the determined location and/or orientation of the HWD 150, the determined gaze direction of the user, and/or hand tracking measurement. Moreover, through the communication link, the communication interface 165 may receive from the console 110 image data indicating or corresponding to an image to be rendered and additional data associated with the image.

In some implementations, the image renderer 170 includes an electronic component or a combination of an electronic component and a software component that generates one or more images for display, for example, according to a change in view of the space of the artificial reality. In some implementations, the image renderer 170 is implemented as a processor (or a graphical processing unit (GPU)) that executes instructions to perform various functions described herein. The image renderer 170 may receive, through the communication interface 165, image data describing an image of artificial reality to be rendered and additional data associated with the image, and render the image through the electronic display 175. In some implementations, the image data from the console 110 may be encoded, and the image renderer 170 may decode the image data to render the image. In some implementations, the image renderer 170 receives, from the console 110 in additional data, object information indicating virtual objects in the artificial reality space and depth information indicating depth (or distances from the HWD 150) of the virtual objects. In one aspect, according to the image of the artificial reality, object information, depth information from the console 110, and/or updated sensor measurements from the sensors 155, the image renderer 170 may perform shading, reprojection, and/or blending to update the image of the artificial reality to correspond to the updated location and/or orientation of the HWD 150. Assuming that a user rotated his head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality. In some implementations, the image renderer 170 receives hand model data indicating a shape, a location and an orientation of a hand model corresponding to the hand of the user, and overlay the hand model on the image of the artificial reality. Such hand model may be presented as a visual feedback to allow a user to provide various interactions within the artificial reality.

In some implementations, the electronic display 175 is an electronic component that displays an image. The electronic display 175 may, for example, be a liquid crystal display or an organic light emitting diode display. The electronic display 175 may be a transparent display that allows the user to see through. In some implementations, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some implementations, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some implementations, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some implementations, the console 110 is an electronic component or a combination of an electronic component and a software component that provides content to be rendered to the HWD 150. In one aspect, the console 110 includes a communication interface 115 and a content provider 130. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 150 in a physical space into a virtual space (or simultaneous localization and mapping (SLAM) data), eye tracking data, motion vector information, depth information, edge information, object information, etc. The console 110 may provide the image data and the additional data to the HWD 150 for presentation of the artificial reality. In other implementations, the console 110 includes more, fewer, or different components than shown in FIG. 1. In some implementations, the console 110 is integrated as part of the HWD 150.

In some implementations, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., wireless link). Through the communication link, the communication interface 115 may receive from the HWD 150 data indicating the determined location and/or orientation of the HWD 150, the determined gaze direction of the user, and the hand tracking measurement. Moreover, through the communication link, the communication interface 115 may transmit to the HWD 150 image data describing an image to be rendered and additional data associated with the image of the artificial reality.

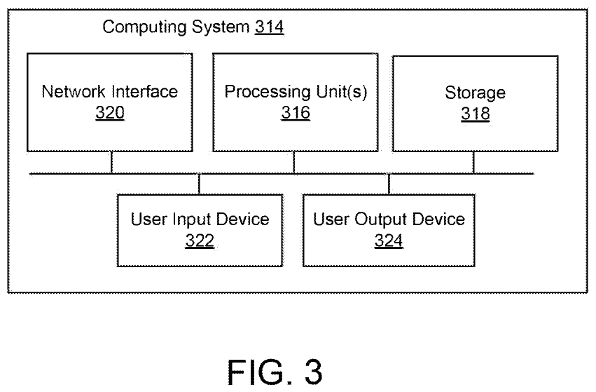

The content provider 130 can include or correspond to a component that generates content to be rendered according to the location and/or orientation of the HWD 150. In some implementations, the content provider 130 may incorporate the gaze direction of the user of the HWD 150, and a user interaction in the artificial reality based on hand tracking measurements to generate the content to be rendered. In one aspect, the content provider 130 determines a view of the artificial reality according to the location and/or orientation of the HWD 150. For example, the content provider 130 maps the location of the HWD 150 in a physical space to a location within an artificial reality space, and determines a view of the artificial reality space along a direction corresponding to the mapped orientation from the mapped location in the artificial reality space. The content provider 130 may generate image data describing an image of the determined view of the artificial reality space, and transmit the image data to the HWD 150 through the communication interface 115. The content provider 130 may also generate a hand model corresponding to a hand of a user of the HWD 150 according to the hand tracking measurement, and generate hand model data indicating a shape, a location, and an orientation of the hand model in the artificial reality space. In some implementations, the content provider 130 may generate additional data including motion vector information, depth information, edge information, object information, hand model data, etc., associated with the image, and transmit the additional data together with the image data to the HWD 150 through the communication interface 115. The content provider 130 may encode the image data describing the image, and can transmit the encoded data to the HWD 150. In some implementations, the content provider 130 generates and provides the image data to the HWD 150 periodically (e.g., every 11 ms). In one aspect, the communication interface 115 can adaptively transmit the additional data to the HWD 150 as described below with respect to FIGS. 3 through 6.

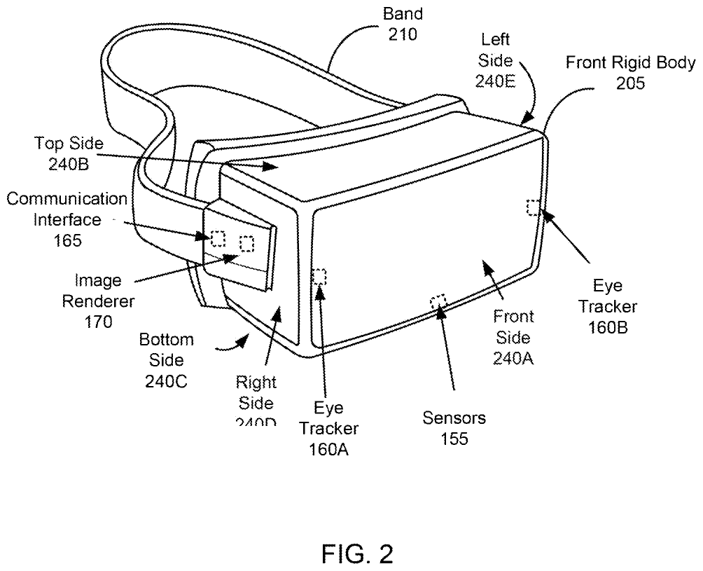

FIG. 2 is a diagram of a HWD 150, in accordance with an example implementation. In some implementations, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the implementation shown by FIG. 2, the communication interface 165, the image renderer 170, and the sensors 155 are located within the front rigid body 205, and may not visible to the user. In other implementations, the HWD 150 has a different configuration than shown in FIG. 2. For example, the communication interface 165, the image renderer 170, the eye trackers 160A, 160B, and/or the sensors 155 may be in different locations than shown in FIG. 2.

Various operations described herein can be implemented on computer systems. FIG. 3 shows a block diagram of a representative computing system 314 usable to implement the present disclosure. In some implementations, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some implementations, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

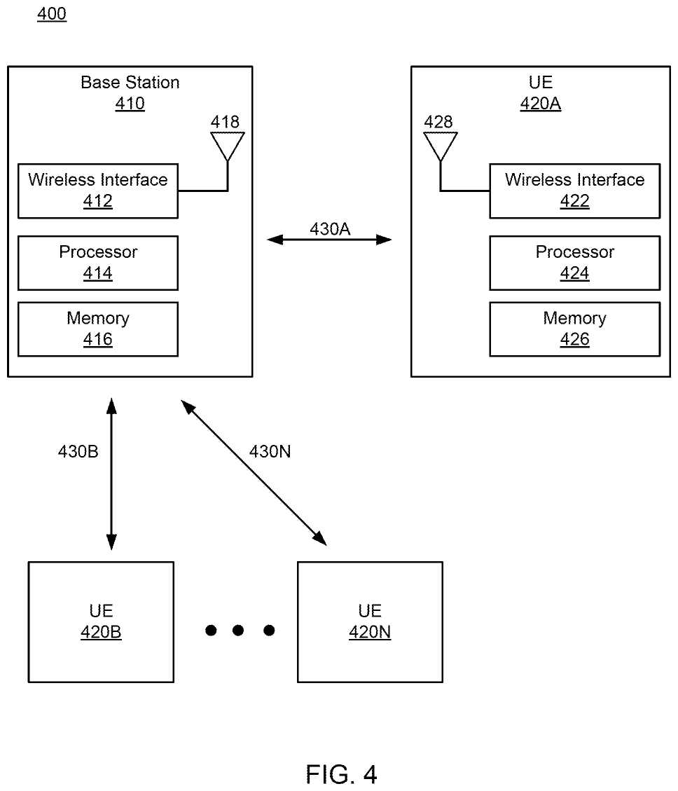

FIG. 4 illustrates an example wireless communication system 400. The wireless communication system 400 may include a base station 410 (also referred to as “a wireless communication node 410” or “a station 410”) and one or more user equipment (UEs) 420 (also referred to as “wireless communication devices 420” or “terminal devices 420”). The UEs 420 may be or include any device or component described above with reference to FIG. 1-FIG. 3, such as the console 110, head wearable display 150, or the like. The base station 410 and UEs 420 may include components, elements, and/or hardware similar to those described above with reference to FIG. 1-FIG. 3. The base station 410 and the UEs 420 may communicate through wireless commination links 430A, 430B, 430C. The wireless communication link 430 may be a cellular communication link conforming to 3G, 4G, 5G or other cellular communication protocols or a Wi-Fi communication protocol. In one example, the wireless communication link 430 supports, employs or is based on an orthogonal frequency division multiple access (OFDMA). In one aspect, the UEs 420 are located within a geographical boundary with respect to the base station 410, and may communicate with or through the base station 410. In some implementations, the wireless communication system 400 includes more, fewer, or different components than shown in FIG. 4. For example, the wireless communication system 400 may include one or more additional base stations 410 than shown in FIG. 4.

In some implementations, the UE 420 may be a user device such as a mobile phone, a smart phone, a personal digital assistant (PDA), tablet, laptop computer, wearable computing device, etc. Each UE 420 may communicate with the base station 410 through a corresponding communication link 430. For example, the UE 420 may transmit data to a base station 410 through a wireless communication link 430, and receive data from the base station 410 through the wireless communication link 430. Example data may include audio data, image data, text, etc. Communication or transmission of data by the UE 420 to the base station 410 may be referred to as an uplink communication. Communication or reception of data by the UE 420 from the base station 410 may be referred to as a downlink communication. In some implementations, the UE 420A includes a wireless interface 422, a processor 424, a memory device 426, and one or more antennas 428. These components may be embodied as hardware, software, firmware, or a combination thereof. In some implementations, the UE 420A includes more, fewer, or different components than shown in FIG. 4. For example, the UE 420 may include an electronic display and/or an input device. For example, the UE 420 may include additional antennas 428 and wireless interfaces 422 than shown in FIG. 4.

The antenna 428 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 428 may be a dipole antenna, a patch antenna, a ring antenna, or any suitable antenna for wireless communication. In one aspect, a single antenna 428 is utilized for both transmitting the RF signal and receiving the RF signal. In one aspect, different antennas 428 are utilized for transmitting the RF signal and receiving the RF signal. In one aspect, multiple antennas 428 are utilized to support multiple-in, multiple-out (MIMO) communication.

The wireless interface 422 includes or is embodied as a transceiver for transmitting and receiving RF signals through a wireless medium. The wireless interface 422 may communicate with a wireless interface 412 of the base station 410 through a wireless communication link 430A. In one configuration, the wireless interface 422 is coupled to one or more antennas 428. In one aspect, the wireless interface 422 may receive the RF signal at the RF frequency received through antenna 428, and downconvert the RF signal to a baseband frequency (e.g., 0˜1 GHz). The wireless interface 422 may provide the downconverted signal to the processor 424. In one aspect, the wireless interface 422 may receive a baseband signal for transmission at a baseband frequency from the processor 424, and upconvert the baseband signal to generate a RF signal. The wireless interface 422 may transmit the RF signal through the antenna 428.

The processor 424 is a component that processes data. The processor 424 may be embodied as field programmable gate array (FPGA), application specific integrated circuit (ASIC), a logic circuit, etc. The processor 424 may obtain instructions from the memory device 426, and executes the instructions. In one aspect, the processor 424 may receive downconverted data at the baseband frequency from the wireless interface 422, and decode or process the downconverted data. For example, the processor 424 may generate audio data or image data according to the downconverted data, and present an audio indicated by the audio data and/or an image indicated by the image data to a user of the UE 420A. In one aspect, the processor 424 may generate or obtain data for transmission at the baseband frequency, and encode or process the data. For example, the processor 424 may encode or process image data or audio data at the baseband frequency, and provide the encoded or processed data to the wireless interface 422 for transmission.

The memory device 426 is a component that stores data. The memory device 426 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 426 may be embodied as a non-transitory computer readable medium storing instructions executable by the processor 424 to perform various functions of the UE 420A disclosed herein. In some implementations, the memory device 426 and the processor 424 are integrated as a single component.

In some implementations, each of the UEs 420B . . . 420N includes similar components of the UE 420A to communicate with the base station 410. Thus, detailed description of duplicated portion thereof is omitted herein for the sake of brevity.

In some implementations, the base station 410 may be an evolved node B (eNB), a serving eNB, a target eNB, a femto station, or a pico station. The base station 410 may be communicatively coupled to another base station 410 or other communication devices through a wireless communication link and/or a wired communication link. The base station 410 may receive data (or a RF signal) in an uplink communication from a UE 420. Additionally or alternatively, the base station 410 may provide data to another UE 420, another base station, or another communication device. Hence, the base station 410 allows communication among UEs 420 associated with the base station 410, or other UEs associated with different base stations. In some implementations, the base station 410 includes a wireless interface 412, a processor 414, a memory device 416, and one or more antennas 418. These components may be embodied as hardware, software, firmware, or a combination thereof. In some implementations, the base station 410 includes more, fewer, or different components than shown in FIG. 4. For example, the base station 410 may include an electronic display and/or an input device. For example, the base station 410 may include additional antennas 418 and wireless interfaces 412 than shown in FIG. 4.

The antenna 418 may be a component that receives a radio frequency (RF) signal and/or transmit a RF signal through a wireless medium. The antenna 418 may be a dipole antenna, a patch antenna, a ring antenna, or any suitable antenna for wireless communication. In one aspect, a single antenna 418 is utilized for both transmitting the RF signal and receiving the RF signal. In one aspect, different antennas 418 are utilized for transmitting the RF signal and receiving the RF signal. In one aspect, multiple antennas 418 are utilized to support multiple-in, multiple-out (MIMO) communication.

The wireless interface 412 includes or is embodied as a transceiver for transmitting and receiving RF signals through a wireless medium. The wireless interface 412 may communicate with a wireless interface 422 of the UE 420 through a wireless communication link 430. In one configuration, the wireless interface 412 is coupled to one or more antennas 418. In one aspect, the wireless interface 412 may receive the RF signal at the RF frequency received through antenna 418, and downconvert the RF signal to a baseband frequency (e.g., 0˜1 GHz). The wireless interface 412 may provide the downconverted signal to the processor 424. In one aspect, the wireless interface 422 may receive a baseband signal for transmission at a baseband frequency from the processor 414, and upconvert the baseband signal to generate a RF signal. The wireless interface 412 may transmit the RF signal through the antenna 418.

The processor 414 is a component that processes data. The processor 414 may be embodied as FPGA, ASIC, a logic circuit, etc. The processor 414 may obtain instructions from the memory device 416, and executes the instructions. In one aspect, the processor 414 may receive downconverted data at the baseband frequency from the wireless interface 412, and decode or process the downconverted data. For example, the processor 414 may generate audio data or image data according to the downconverted data. In one aspect, the processor 414 may generate or obtain data for transmission at the baseband frequency, and encode or process the data. For example, the processor 414 may encode or process image data or audio data at the baseband frequency, and provide the encoded or processed data to the wireless interface 412 for transmission. In one aspect, the processor 414 may set, assign, schedule, or allocate communication resources for different UEs 420. For example, the processor 414 may set different modulation schemes, time slots, channels, frequency bands, etc. for UEs 420 to avoid interference. The processor 414 may generate data (or UL CGs) indicating configuration of communication resources, and provide the data (or UL CGs) to the wireless interface 412 for transmission to the UEs 420.

The memory device 416 is a component that stores data. The memory device 416 may be embodied as RAM, flash memory, ROM, EPROM, EEPROM, registers, a hard disk, a removable disk, a CD-ROM, or any device capable for storing data. The memory device 416 may be embodied as a non-transitory computer readable medium storing instructions executable by the processor 414 to perform various functions of the base station 410 disclosed herein. In some implementations, the memory device 416 and the processor 414 are integrated as a single component.

In some implementations, communication between the base station 410 and the UE 420 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

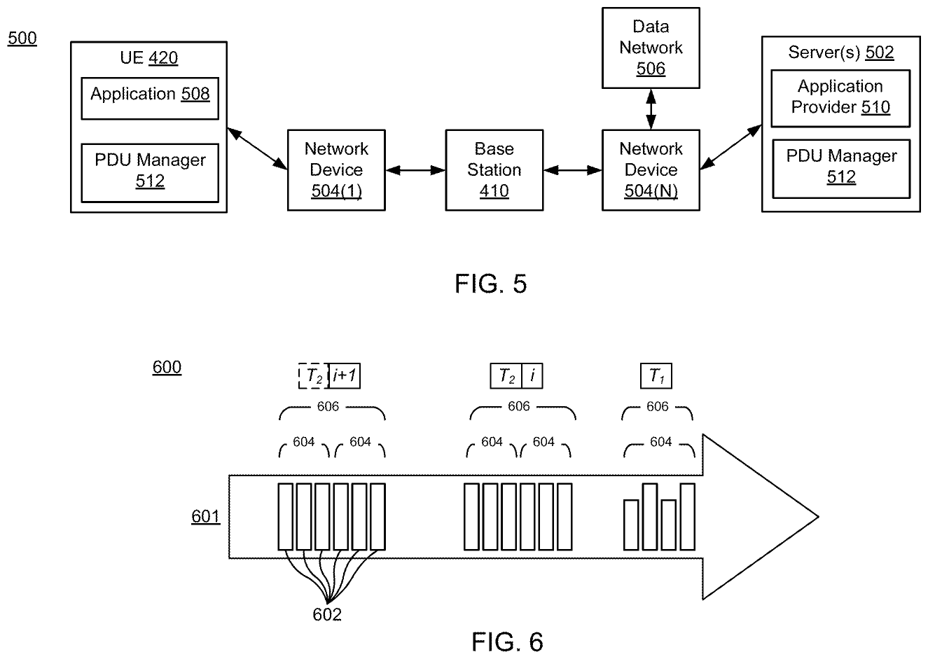

Referring now to FIG. 5, depicted is a block diagram of a system 500 that can implement operations including facilitating delay aware scheduling of network data communications, according to an example implementation of the present disclosure. The system 500 may include user equipment (UE) 420 communicably coupled to one or more server(s) 502. The UE 420 may be the same as or similar to the UE 420 described above with reference to FIG. 4. The UE 420 may be communicably coupled to the server(s) 502 via various network devices 504 and base station 410. The base station 410 may be the same as or similar to the base station 410 described above with reference to FIG. 4. The network devices 504 may be or include any networking device, component, or node along the network path between the UE 420 and server(s) 502. For example, the network devices 504 may include routers, switches, or any other network nodes. In various implementations, the server(s) 502 may be configured to communicate with a data network 506 (e.g., a trusted data network 506) via a network exposure function and/or policy control function). The server(s) 502 may be configured to communicate data via a user plane function (UPF) to the base station 410 (e.g., a radio access network [RAN]), and the base station 410 may route the data from the server(s) 502 via various network devices 504 to the UE 420.

The UE 520 may be configured to execute an application 508 hosted by an application provider 510 on the server(s) 502. In various implementations, the application 508 may be an extended reality (XR) application (e.g., an augmented reality (AR), virtual reality (VR), mixed reality (MR), or other XR application). The application 508 executing on the UE 420 may generate data for transmission to the server 502 (and vice versa). The UE 420 (or server 502) may be configured to transmit the data along the network path shown in FIG. 5 and described above to the endpoint or destination (e.g., to the server 502 or UE 420).

A device or node along the network path may include a PDU manager 512 (e.g., communication manager, data burst manager). The PDU manager 512 can include one or more rules, heuristics, algorithms, policies, logic, models (e.g., machine learning models), algorithms, or functions to perform operations including allocating PDUs to data buffers and managing delay information relating to and/or discard of PDUs (e.g., PDUs 602 of a PDU set 604 as described with reference to FIG. 6). While shown as included in the UE 420 and server(s) 502, in various implementations, each node (e.g., the network devices 504, base station 410, data network 506, etc.) may execute or include an instance of the PDU manager 512. In some implementations, the PDU manager 512 may be configured to execute a PDU-set delay budget (PSDB). The PSDB may define an upper bound for the time that a PDU set 604 may be delayed between two nodes of the network path (e.g., between the UE 420 and base station network device 504(1), network device 504(1) and base station 410, base station 410 and network device 504(N), and/or network device 504(N) and sever(s) 502). In various implementations, the PSDB may define an upper bound for the time that a PDU set 604 may be delayed for both downlink (DL) and/or uplink (UL) traffic. For certain cellular quality of service (QOS) identifiers (e.g., 5QI), the values for the PSDB for UL and DL traffic may be the same. In the case of network access, the PSDB may be used to support the configuration of scheduling and link layer functions. In some implementations, the PDU manager 512 may be configured to execute a PDU set discard time (PSDT). The PSDT may be an upper bound for the time that a PDU set 604 is to wait for transmission (e.g., in a buffer) at the sender of a link layer protocol before being discarded. Similar to the PSDB, the PSDT may be applied to both UL and DL traffic.

The PDU manager 512 may be configured to selectively discard PDU sets 604 and/or data bursts 606 based on or according to the PDU set discard policy and/or data burst discard policy. For example, the PDU manager 512 may be configured to selectively discard PDU sets 604 and/or data bursts 606, based on or according to a count of PDUs 602 (e.g., of a PDU set 604 and/or of a data burst 606) received or otherwise identified by the PDU manager 512 within a time window. The time window may be, for example, set according to one of the discard policies. For instance, the time window may be a duration starting from receipt of a first PDU 602 of a PDU set 604. The PDU manager 512 may be configured to count the number of PDUs 602 received within the time window, and can apply the PDU set discard policy and/or data burst discard policy to the received PDUs 602, to selectively discard (or process) the PDU set 604 and/or data burst 606. The PDU manager 512 may be configured to discard the PDU set 604 and/or data burst 606 by deleting the PDU sets 604 (e.g., each PDU 602 which are linked to a common PDU set 604) or data burst 606 (e.g., each PDU set 604 sent in a common data burst 606) from memory, by removing the PDU sets 604 and/or data bursts 606 from a buffer, by dropping the PDU sets 604 and/or data bursts 606 from a transmission schedule for transmission, etc. The PDU manager 512 may be configured to process the PDU sets 604 (or data bursts 606) by transmitting the PDU sets 604 or data bursts 606 received from a buffer 601 (e.g., from the application layer following the application 508 moving the PDU sets 604 to the buffer 601) to the next node along the network path, by pushing the PDU sets 604 (or data bursts 606) to the application layer for decoding and use by the application 508, etc.

Referring now to FIG. 6, depicted is a diagram of traffic flow 600 (e.g., for transmission from a sender device to a receiver device) associated with a data buffer 601, according to an example implementation of the present disclosure. In some implementations, the sender device may be the UE 420 and the receiver device may be the server 502. In some implementations, the sender device may be a network device 504 and the receiver device may be the base station 410. In some implementations, the sender device may be the base station 410 and the receiver device may be the server 502 and/or the UE 420. In this regard, the sender device and receiver device may be or include any node along the network path shown in FIG. 5.

As shown in FIG. 6, the traffic flow 600 may include protocol data units (PDUs) 602 which may be grouped or otherwise sent in a PDU set 604. The PDUs 602, PDU sets 604, and/or data bursts 606 can be allocated to the data buffer 601. For example, the data buffer 601 can be or include a logical and/or physical (e.g., in hardware memory) sequence of data to be transmitted, e.g. in accordance with an order in which the data is allocated to the data buffer 601. The traffic flow 600 and/or data buffer 601 can be managed by the PDU manager 512, such as to allocate PDUs 602, PDU sets 604, and/or data bursts 606 to the data buffer 601, to maintain discard timing with respect to PDUs 602, and/or to discard PDUs 602 in accordance with discard timing.

In some implementations, multiple PDU sets 604 may be sent in a data burst 606. In this regard, a sender device may generate a PDU set 604 including one or more PDUs 602. Each PDU 602 may include, contain, or otherwise carry various unit(s) of information generated at the application level (e.g., by the application 508, for example). For example, where the application 508 is an XR application, a PDU 602 may include a frame or video slice for the XR application. In some implementations, each of the PDUs 602 in the PDU set are needed by the application 508 (or the receiver device) to use the corresponding unit of information.

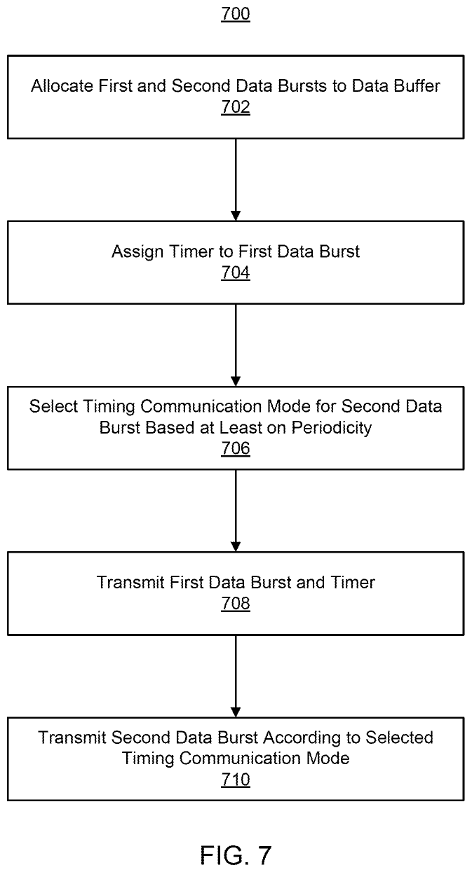

One or more PDUs 602 (and/or PDU sets 604) can be subject to timing criteria for transmission of the PDUs 602. For example, the PDU 602 can be subject to timing criteria such as a threshold duration (e.g., upper bound) that the PDU 602 is in a buffer (e.g., in the traffic flow 600; in a buffer 704 described with reference to FIG. 7) for transmission before being discarded, such that the PDU manager 512 can discard the PDU 602 responsive to an amount of time that the PDU 602 is in the buffer meeting or exceeding the threshold duration. This can be useful, for example, for latency-sensitive communications in which PDUs 602 may represent data that if not communicated in time may not be useful for a receiving device. XR data, such as video frames for XR, can be examples of such latency-sensitive communications for which the timing criteria and discard are useful. The timing criteria can include at least one of the PSDB or the PSDT. The UE 420 (e.g., PDU manager 512) can determine an indication of a remaining time that a given PDU 602 has to be in the buffer until the threshold duration of the timing criteria will be met or exceeded. For example, if the threshold duration is 80 ms, and the UE 420 determines that the given PDU 602 has been in the buffer for 50 ms, the UE 420 can determine the remaining time to be 30 ms.

Referring further to FIG. 6, as depicted, the traffic flow 600 in the data buffer 601 can include a first data burst 606, a second data burst 606, and a third data burst 606 (e.g., from right to left, such that the right-most data burst 606 is to be outputted first from the data buffer 601, followed by the second data burst 606, followed by the third data burst 606). The first data burst 606 can represent non-periodic traffic (e.g., receiver-triggered data). The second data burst 606 and third data burst 606 can represent periodic traffic. For example, the second and third data bursts 606 can represent periodic data outputted by a same application, such as XR data. The second and third data bursts 606 (e.g., PDUs 602 of the second data bursts 606) can be generated by the application 508 to have the same PDU set importance score.

The PDU manager 512 can assign timing information, such as timing information corresponding to delay and/or delay-related timing criteria for communication of data, to PDUs 602 (and/or PDU sets 604 and/or data bursts 606). The timing information can include a timer. The timer can represent an amount of time until one or more timing criteria for output of the PDUs 602 expire. The timing criteria can include, for example, at least one of the PSDB or the PSDT. The PDU manager 512 can periodically update the timer, such as to increment or decrement the timer with time as time advances. In some implementations, where one or more timing criteria (e.g., PSDB, PSDT) are applicable to a given PDU 602, the PDU manager 512 can discard the given PDU 602 responsive to the timer indicating that the amount of time for which the PDU 602 can be maintained in the data buffer 601 is exceeded (e.g., the timer goes to zero in instances where the PDU manager 512 decrements the timer; the timer exceeds the PSDB and/or PSDT in instances where the PDU manager 512 increments the timer).

The PDU manager 512 can assign the timing information to various data elements associated with the data bursts 606. For example, the PDU manager 512 can assign the timing information based on and/or to at least one of a header, a buffer status report element, a start frame, or an end frame for the data burst 606.

The PDU manager 512 can selectively determine whether to assign and/or how to assign timing information, such as explicit timers, to data bursts 606. In some implementations, the PDU manager 512 determines whether to assign timing information according to a timing characteristic of the data bursts 606, such as a periodicity of the data bursts 606. The PDU manager 512 can identify the timing characteristic by any of various operations, including but not limited to by parsing a header or other information associated with the PDUs 602 and/or data bursts 606 as outputted by the application 508 to detect an identifier of the type of data represented by the PDUs 602 (e.g., XR data vs. data indicating operations for control of the application 508, for example).

Responsive to determining that a given data burst 606 represents non-periodic data (e.g., aperiodic data; receiver-triggered data; data requested from an application server (e.g., from application provider 510 of server(s) 502), the PDU manager 512 can assign the timer to the given data burst 606 to be specific to the data burst 606, such as to be specific to one or more PDUs 602 and/or PDU sets 604 of the data burst 606. For example, the PDU manager 512 can select the value of the timer and/or timing information to be assigned to the given data burst 606 based at least on the type of data represented by the PDUs 602 (e.g., from a lookup table).

Responsive to determining that a given data burst 606 represents periodic data, the PDU manager 512 can assign the timer for the given data burst 606; this can include, in some implementations, selectively assigning the timer based on whether the given data burst 606 is subsequent to periodic data. For example, where the given data burst 606 follows a prior data burst 606 that represents periodic traffic, such as where both data bursts 606 are generated as periodic data from the same application, the PDU manager 512 can determine not to assign the timer to the given data burst 606. This can allow for reduced overhead, since a data element for the timer need not be generated and transmitted; instead, indexing for the given data burst 606, due to the given data burst 606 being periodic, can be used to implicitly indicate the timing information. In some implementations, the selection of assigning or not assigning timing information is performed at the PDU set 604 level (e.g., assign timing information to a first PDU 602 of a PDU set 604 to avoid assigning for the remaining PDUs 602 of the PDU set 604).

For example, as depicted in FIG. 6, the first data burst 606 can be for non-periodic data. The PDU manager 512 can assign the timing information T₁ specific to the first data burst 606 responsive to the first data burst 606 being for non-periodic data. The second data burst 606 and the third data burst 606 can be for periodic data, such as XR data generated by the application 508. The PDU manager 512 can assign the timing information T₂ to the second data burst 606, such as based at least on the second data burst 606 representing periodic data and being subsequent to the first data burst 606 that has non-periodic data (or if the first data burst 606 had data of a different periodicity than the second data burst 606). The PDU manager 512 can assign an index i to the second data burst 606 (while not depicted, the first data burst 606 may also have an index, e.g. i−1). The PDU manager 512 can avoid assigning timing information to the third data burst 606 responsive to the third data burst 606 being of periodic data (e.g., of the same periodicity as the second data burst 606) and being subsequent to the second data burst 606, since the timing information T₂ assigned to the second data burst 606 can also represent the timing information for the third data burst 606. The PDU manager 512 can assign the index i+1 to the third data burst 606; as such, due to the common periodicity of the second and third data bursts 606, the index i+1 can be used to represent the timing information for the third data burst 606, such that overhead (e.g., a bit or other data element in a header of the third data burst 606) need to be allocated in order to communicate the timing information T₂ for the third data burst 606.

In some implementations, the PDU manager 512 can monitor the synchronization of the data bursts 606 relative to the timing information, and can provide a signal indicative of a difference from synchronization, such as to indicate that the use of the indexing to convey the timing information may not be sufficient. This can allow the PDU manager 512 to effectively maintain the ability to provide delay information even under congestion or other conditions in which timing may vary from periodic communication timing. In some implementations, the PDU manager 512 can monitor a difference of timing of output of the data bursts 606 (or PDUs 602 and/or PDU sets 604 thereof) relative to an expected timing corresponding to the timer, such as an expected timing represented by the periodicity (e.g., 11 ms or 16 ms communication of XR frames), and can transmit, responsive to the difference meeting a correction condition (e.g., exceeding a threshold), an indication of the difference. The PDU manager 512 can include any of various layers of communication to transmit the indication, including but not limited to the MAC control element (MAC-CE), such as using a data buffer overflow element of MAC-CE.

In some implementations, the PDU manager 512 maps data bursts 606 of periodic traffic and non-periodic traffic to different communication channels, such as to different logical channels (LCHs). For example, the PDU manager 512 can select a first LCH for the first data burst 606 responsive to the first data burst 606 representing non-periodic data, and can select a second LCH for at least one of the second data burst 606 and the third data burst 606 responsive to the at least one of the second data burst 606 and the third data burst 606 representing periodic traffic.

In some implementations, the PDU manager 512 uses the timing information (e.g., timer T₂ for the second data burst 606; index i+1 for the third data burst 606) to control discard of data of the data bursts 606. For example, the PDU manager 512 can discard a given PDU 602 of the second data burst 606 responsive to the timer T₂ expiring with respect to the timing criteria for the second data burst 606, such as to exceed the PSDB and/or PSDT for the second data burst 606. The PDU manager can discard a given PDU 602 of the third data burst 606 based on a remaining time determined using the index i+1 and the timer T₂ (e.g., rather than an independently determined timer for the third data burst 606).

FIG. 7 shows a flow diagram of a representative method 700 for remaining time information communication for delay aware scheduling. In some implementations, the method 700 can be implemented by a device, such as a UE, configured to communicate with a second device, such as a base station, using a wireless connection. In some implementations, the method can be implemented for communication between UEs, or for communication from a base station to a UE. In brief overview, the method can include allocating 702 a first data burst and a second data burst to a data buffer. The method can include assigning 704 a timer to the first data burst. The method can include selecting 706 a communication mode for the second data burst based at least on the second data burst being representative of periodic network traffic. The method can include transmitting 708 the first data burst and the timer. The method can include transmitting 710 the second data burst according to the selected timing communication mode. In some implementations, the method 700 can be performed by the wearable device 110 or the wearable device 150. In some implementations, the method 700 can be performed by other entities. In some implementations, the method 700 includes more, fewer, or different steps than shown in FIG. 7.

Referring to FIG. 7 in further detail, one or more processors of the device can allocate 702 a first data burst and a second data burst to a data buffer. The data bursts can each include one or more PDU sets, such as where each PDU set includes one or more PDUs carrying a payload of a unit of information generated at an application level, such as a frame or video slice for XR services. For example, the PDU sets can be arranged in data bursts, such as to have a plurality of first data packets forming a first data burst and a plurality of second data packets forming a second data burst, the first data burst having a first period between consecutive packets of the plurality of first data packets, the second data burst having a second period between consecutive packets of the plurality of second data packets, the first period and the second period each less than a third period between the first data burst and the second data burst. The PDU sets can represent XR data, such as for the first PDU set to represent an I frame, and the second PDU set to represent a P frame. The PDUs of the first and second data bursts can be generated by a same application and can have a same value of a PDU set importance score. The data bursts can represent periodic data (e.g., XR data such as image, audio, and/or video data to be communicated in a periodic manner corresponding to a frame rate of the XR services) and/or non-periodic data (e.g., receiver-triggered data; aperiodic data). The data buffer can include at least one of a logical or hardware (e.g., memory) elements to order and/or store the data of the data bursts for transmission of the data bursts. The PDUs, PDU sets, and/or data bursts can have one or more timing criteria, such as at least one of PSDB or PSDT. In some implementations, each PDU set of a given data burst has a same remaining time, where the remaining time is based on a remaining amount of time budget, such as a remaining amount of time that the PDU set can be maintained in the buffer until the one or more timing criteria expire.

The one or more processors can assign 704 a timer to the first data burst. The timer can correspond to the remaining time. For example, the timer can be a value to be incremented or decremented over time, and can be evaluated with respect to the one or more timing criteria to determine the remaining amount of time that the PDU sets of the data burst can be maintained in the buffer until the one or more timing criteria expire. In some implementations, the timer is assigned to the first data burst responsive to the first data burst immediately following a data burst that is at least one of non-periodic or of a different periodicity than the first data burst (as there may not be an earlier data burst from which timing information can be imputed to the first data burst). Assigning the timer to the first data burst can include setting a value for the timer to one or more data elements associated with the first data burst, including, for example, a header, a start frame, and/or an end frame for the first data burst.

The one or more processors can select 706 a timing communication mode for the second data burst based on a periodicity (e.g., at least one of whether the second data burst represents periodic data or a value of the periodicity, such as frame rate, of the second data burst) of the second data burst. For example, responsive to the second data burst representing periodic data, the one or more processors can select the timing communication mode to be to not assign a timer to the second data burst, such as to use indexing of the second data burst to represent the timing information for the second data burst, since the remaining time for the second data burst can be determined based on the timer assigned to the first data burst and the periodicity of the second data burst. Responsive to the second data burst representing non-periodic data, the one or more processors can select the timing communication mode to be to assign a (second) timer to the second data burst. In some implementations, assigning the timers to the respective data bursts includes identifying a type of the data of the respective data bursts, which can be used to retrieve the respective timers, such as from a lookup table. In some implementations, the one or more processors select an LCH for communication of the second data burst responsive to whether the second data burst represents periodic data (e.g., selects a first LCH for periodic data or a second LCH responsive to the second data burst representing non-periodic data).

In some implementations, the method 700 includes monitoring a synchronization of the timing of the data bursts, such as to indicate out of sync timing information. For example, the one or more processors can provide a control signal, such as at least one of a MAC-CE signal, a data buffer overflow signal, or a buffer status report (BSR) signal, to indicate a difference between an expected time of communication of data corresponding to a periodicity of the data bursts and a monitored time of communication (e.g., responsive to the difference being greater than a threshold).

The one or more processors can transmit 708 the first data burst and the timer for the first data burst (e.g., responsive to the one or more timing criteria not expiring by the time the first data burst can be outputted from the data buffer for transmission). For example, the one or more processors can cause a wireless communications interface to receive the first data burst, along with the timer assigned to the first data burst, from the data buffer, and can cause the wireless communications interface to transmit the first data burst to a remote device for reception of the first data burst. Transmitting the first data burst can include transmitting an index of the first data burst.

The one or more processors can transmit 710 the second data burst and the index for the second data burst (e.g., responsive to the one or more timing criteria not expiring by the time the second data burst can be outputted from the data buffer for transmission). For example, the one or more processors can cause a wireless communications interface to receive the second data burst, along with the index assigned to the second data burst, from the data buffer, and can cause the wireless communications interface to transmit the second data burst to a remote device for reception of the second data burst.

Some implementations include electronic components, such as microprocessors, storage and memory that store computer program instructions in a computer readable storage medium (e.g., non-transitory computer readable medium). Many of the features described in this disclosure can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, the processors 316 can provide various functionality for the computing system 314, including any of the functionality described herein as being performed by a server or client, or other functionality associated with message management services.

It will be appreciated that the computing system 314 is illustrative and that variations and modifications are possible. Computer systems used in connection with the present disclosure can have other capabilities not specifically described here. Further, while the computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the implementations disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary implementations, and that such variations are intended to be encompassed by the present disclosure.

What is claimed is:

1. A device, comprising:
a wireless communications interface; and
one or more processors to:
allocate at least a first data burst and a second data burst to a data buffer;
assign, to the first data burst, a timer corresponding to an amount of time for output of the first data burst until one or more timing criteria expire;
assign, to the second data burst, responsive to the first data burst and the second data burst each representing periodic network traffic, an index indicative of the position of the second data burst in the data buffer relative to the first data burst; and
cause the wireless communications interface to transmit the first data burst and the timer for the first data burst, and to transmit the second data burst and the index for the second data burst.

2. The device of claim 1, wherein the one or more processors are to assign the timer in a header associated with the first data burst.

3. The device of claim 1, wherein the one or more processors are to not assign the timer to the second data burst responsive to the first data burst and the second data burst each representing periodic network traffic.

4. The device of claim 1, wherein the first data burst and the second data burst each comprise one or more of protocol data unit (PDU) sets.

5. The device of claim 4, wherein the one or more processors are to:
generate the one or more PDU sets of the first data burst and the second data burst using a same application; and
assign, to the one or more PDU sets of the first data burst and the second data burst, a same value of a PDU set importance score.

6. The device of claim 1, wherein the first data burst and the second data burst are each representative of at least one of image data, audio data, or video data.

7. The device of claim 1, wherein the one or more processors are to:
monitor a difference of timing of output of the second data burst relative to an expected timing corresponding to the timer; and
transmit, using the wireless communications interface, responsive to the difference meeting a correction condition, an indication of the difference.

8. The device of claim 1, wherein the one or more timing criteria comprise at least one of a PDU set delay budget (PSDB) or a PDU set discard time (PSDT).

9. A system, comprising:
one or more processors to:
allocate at least a first data burst and a second data burst to a data buffer;
assign, to the first data burst, a timer corresponding to an amount of time for output of the first data burst until one or more timing criteria expire;
assign, to the second data burst, responsive to the first data burst and the second data burst each representing periodic network traffic, an index indicative of the position of the second data burst in the data buffer relative to the first data burst; and
cause a wireless communications interface to transmit the first data burst and the timer for the first data burst, and to transmit the second data burst and the index for the second data burst.

10. The system of claim 9, wherein the one or more processors are to assign the timer in a header associated with the first data burst.

11. The system of claim 9, wherein the one or more processors are to not assign the timer to the second data burst responsive to the first data burst and the second data burst each representing periodic network traffic.

12. The system of claim 9, wherein the first data burst and the second data burst each comprise one or more of protocol data unit (PDU) sets.

13. The system of claim 12, wherein the one or more processors are to:
generate the one or more PDU sets of the first data burst and the second data burst using a same application; and
assign, to the one or more PDU sets of the first data burst and the second data burst, a same value of a PDU set importance score.

14. The system of claim 9, wherein the first data burst and the second data burst are each representative of at least one of image data, audio data, or video data.

15. The system of claim 9, wherein the one or more processors are to:
monitor a difference of timing of output of the second data burst relative to an expected timing corresponding to the timer; and
transmit, using the wireless communications interface, responsive to the difference meeting a correction condition, an indication of the difference.

16. The system of claim 9, wherein the one or more timing criteria comprise at least one of a PDU set delay budget (PSDB) or a PDU set discard time (PSDT).

17. A method, comprising:
allocating, by one or more processors, a first data burst and a second data burst to a data buffer;
assigning, by the one or more processors, to the first data burst, a timer corresponding to an amount of time for output of the first data burst until one or more timing criteria expire;
selecting, by the one or more processors, according to a timing characteristic of the first data burst and the second data burst, one of a timer-based communication mode for communicating remaining time information for the second data burst or an index-based communication mode for communicating the remaining time information for the second data burst;
transmitting, by the one or more processors using a wireless communications interface, the first data burst and the timer; and
transmitting, by the one or more processors using the wireless communications interface, the second data burst according to the selected one of the timer-based communication mode or the index-based communication mode.

18. The method of claim 17, further comprising:
generating, by the one or more processors, the one or more PDU sets of the first data burst and the second data burst using a same application; and
assigning, to the one or more PDU sets of the first data burst and the second data burst, a same value of a PDU set importance score.

19. The method of claim 17, wherein the first data burst and the second data burst are each representative of at least one of image data, audio data, or video data.

20. The method of claim 17, further comprising:
monitoring, by the one or more processors, a difference of timing of output of the second data burst relative to an expected timing corresponding to the timer; and
transmitting, using the wireless communications interface, responsive to the difference meeting a correction condition, an indication of the difference.
